(19) United States
(12) Patent Application Publication
(10) Pub. No.: US 2022/0374810 A1
(43) Pub. Date: Nov. 24, 2022

(54) ACCELERATING OUTLIER PREDICTION OF PERFORMANCE METRICS IN PERFORMANCE MANAGERS DEPLOYED IN NEW COMPUTING ENVIRONMENTS

(71) Applicant: Healtech Software India Pvt. Ltd., Bangalore (IN)

(72) Inventors: Atri Mandal, Bangalore (IN); Arpit Rathi, Bangalore (IN); Raja Shekhar Mulpuri, Bangalore (IN); Vihang Dudhalkar, Bangalore (IN)

(21) Appl. No.: 17/444,673

(22) Filed: Aug. 9, 2021

(30) Foreign Application Priority Data
May 21, 2021 (IN) 202141022793

(51) Int. Cl. G06Q 10/06; G06N 20/20; G06F 11/34; G06K 9/62

(52) U.S. Cl. CPC G06Q 10/06393; G06N 20/20; G06F 11/3428; G06K 9/6257

(57) ABSTRACT

An aspect of the present disclosure facilitates accelerating outlier prediction of performance metrics in performance managers deployed in new computing environments. In one embodiment, a digital processing system receives an input data specifying a business vertical to which a new computing environment is directed, a performance metric of interest, and a computing component of the new computing environment for which the performance metric is sought to be measured. In response, the system selects, from a set of prediction models, a prediction model for the performance metric, based on the input data. The selected prediction model is then used in a performance manager to predict outliers for the performance metric of interest during operation of the new computing environment.

### PRIORITY CLAIM

The instant patent application is related to and claims priority from the co-pending India provisional patent application entitled, “OUTLIER PREDICTION FOR PERFORMANCE METRICS OF SOFTWARE APPLICATIONS”, Serial No.: 202141022793, Filed: 21 May 2021, which is incorporated in its entirety herewith.

### BACKGROUND OF THE DISCLOSURE

### Technical Field

The present disclosure relates to computing infrastructures and more specifically to accelerating outlier prediction of performance metrics in performance managers deployed in new computing environments.

### Related Art

Computing environments contain computing infrastructures and software applications deployed thereon for processing user requests. The computing infrastructures can be cloud infrastructures, enterprise infrastructures, a hybrid of cloud and enterprise infrastructures, as is well known in the relevant arts.

Performance managers are often deployed to aid in the management of the performance of computing environments. Performance management entails examination of inputs (user requests), outputs (responses to user requests) and resource usage while generating the outputs from the inputs. The resources can be infrastructure resources such as compute/CPU, memory/RAM, disk/file storage, etc., or application resources such as database connections, application threads, etc.

Performance managers generate (performance) metrics quantifying aspects of the examination such as input workload character, throughput performance quantifying aspects of the outputs, and resource usage. Each metric may have a sequence of values computed over time based on the values observed for the corresponding aspect.

Outliers are exceptions which deviate substantially from normal metric values determined for other durations. Outliers typically indicates over or under allocation of resources, or potentially even problems in the infrastructure or applications. The normal values and/or the extent of deviations forming the basis for outliers can be pre-specified also, as is well known in the relevant arts.

There is a general need to predict such outliers so that any needed corrective actions can be performed, or at least the expectations set. Such a need exists specifically in performance managers deployed in new computing environments, and it is desirable that the predictions start with reasonably accuracy as soon as possible.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which accelerating outlier prediction of performance metrics in a performance manager deployed in a new computing environment is facilitated according to aspects of the present disclosure.

FIG. 3A depicts the details of a software application in one embodiment.

FIG. 3B depicts the manner in which a software application is deployed in a computing infrastructure in one embodiment.

FIG. 4A is a block diagram depicting an example implementation of a performance manager in one embodiment.

FIG. 4B is a resource table depicting the usage of the resources by a software application (performance metrics) deployed in a computing infrastructure in one embodiment.

FIG. 5A is a block diagram depicting the manner in which a prediction model is selected for usage in a performance manager deployed in a new computing environment in one embodiment.

FIG. 5B is an embedding table depicting the word embeddings corresponding to different combinations and the corresponding models in one embodiment.

FIG. 6 is a block diagram depicting the manner in which a prediction model is selected for usage in a performance manager during operation of a new computing environment in one embodiment.

FIG. 7 is a block diagram illustrating the details of digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates accelerating outlier prediction of performance metrics in performance managers deployed in new computing environments. In one embodiment, a digital processing system receives an input data specifying a business vertical to which a new computing environment is directed, a performance metric of interest, and a computing component of the new computing environment for which the performance metric is sought to be measured. In response, the system selects, from a set of prediction models, a prediction model for the performance metric, based on the input data. The selected prediction model is then used in a performance manager to predict outliers for the performance metric of interest during operation of the new computing environment.

According to another aspect of the present disclosure, the input data (noted above) also includes a business functionality in which the performance metric of interest is sought to be measured.

According to one more aspect of the present disclosure, another set of prediction models is trained based on historical data sets, with each of the prediction model in another set being associated with a respective combination of business vertical, performance metric, business functionality and computing component. The set of prediction models (noted above) is determined from the another set of prediction models by including a suitable prediction model corresponding to each combination.

According to yet another aspect of the present disclosure, the system performs the selection of prediction model by comparing the input data with the combinations associated with the set of prediction models. A specific prediction model in the set of prediction models whose associated specific combination closely matches the input data is identified as the prediction model for the performance metric of interest.

According to an aspect of the present disclosure, the training of the another set of prediction models is continued based on current data sets. The system then determines, at a specific time instance, whether another prediction model of the another set of prediction models is better than the prediction model (earlier selected), another prediction model being associated with the same specific combination. A switch to another prediction model from the prediction model is performed if another prediction model is determined to be better than the prediction model. Accordingly, the system, after the switch, uses another prediction model in the performance manager to predict outliers for the performance metric of interest during operation of the new computing environment.

According to another aspect of the present disclosure, the combinations (noted above) are in the form of corresponding embedded representations. A new supervised model is trained with the model identifiers of the set of prediction models as corresponding labels and the corresponding embedded representations. The system converts the input data to an input embedded representation capturing the business vertical, the performance metric of interest, the computing component and the business functionality. The input embedded representation is provided as an input to the new supervised model, with the comparing and the identifying being performed by the new supervised model, and the prediction model is received as output of the new supervised model.

According to one more aspect of the present disclosure, the input data (noted above) also includes a metric description describing the performance metric of interest, with each of the combinations also including a description of the corresponding performance metric.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

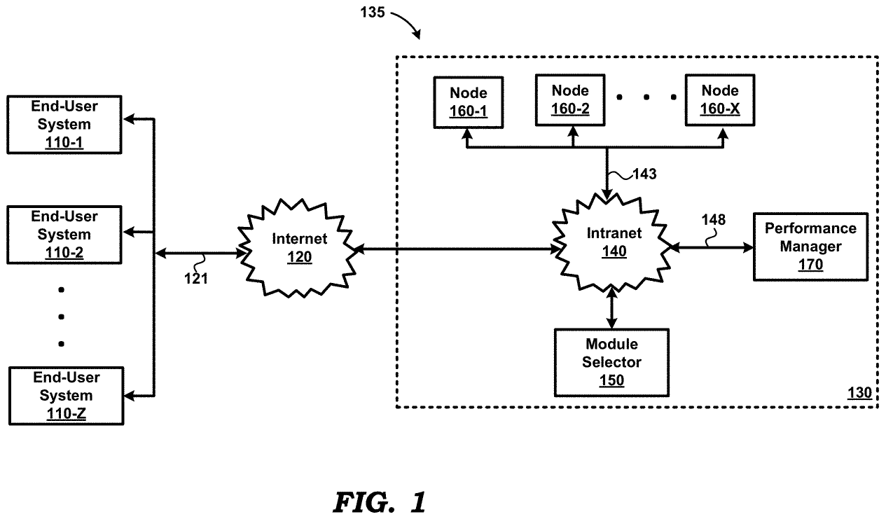

FIG. 1 is a block diagram illustrating an example environment in which several aspects of the present disclosure can be implemented. The block diagram is shown containing end-user systems 110-1 through 110-Z (Z representing any natural number), Internet 120, computing infrastructure 130 and model selector 150. Computing infrastructure 130 in turn is shown containing intranet 140, nodes 160-1 through 160-X (X representing any natural number) and performance manager 170. The end-user systems and nodes are collectively referred to by 110 and 160 respectively.

Merely for illustration, only representative number/type of systems are shown in FIG. 1. Many environments often contain many more systems, both in number and type, depending on the purpose for which the environment is designed. Each block of FIG. 1 is described below in further detail.

Computing infrastructure 130 is a collection of nodes (160) that may include processing nodes, connectivity infrastructure, data storages, administration systems, etc., which are engineered to together host software applications. Computing infrastructure 130 may be a cloud infrastructure (such as Amazon Web Services (AWS) available from Amazon.com, Inc., Google Cloud Platform (GCP) available from Google LLC, etc.) that provides a virtual computing infrastructure for various customers, with the scale of such computing infrastructure being specified often on demand.

Alternatively, computing infrastructure 130 may correspond to an enterprise system (or a part thereof) on the premises of the customers (and accordingly referred to as “On-prem” infrastructure). Computing infrastructure 130 may also be a “hybrid” infrastructure containing some nodes of a cloud infrastructure and other nodes of an on-prem enterprise system.

All the nodes (160) of computing infrastructure 130 are assumed to be connected via intranet 140. Internet 120 extends the connectivity of these (and other systems of the computing infrastructure) with external systems such as end-user systems 110. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranet 140. When the packet contains content such as port numbers, which specifies a target application, the packet may be said to be directed to such application as well.

Each of end-user systems 110 represents a system such as a personal computer, workstation, mobile device, computing tablet etc., used by users to generate (user) requests directed to software applications executing in computing infrastructure 130. A user request refers to a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system requests a software application for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or software application, with the IP packet including data identifying the desired tasks in the payload portion.

Some of nodes 160 may be implemented as corresponding data stores. Each data store represents a non-volatile (persistent) storage facilitating storage and retrieval of enterprise by software applications executing in the other systems/nodes of computing infrastructure 130. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 160 may be implemented as corresponding server systems. Each server system represents a server, such as a web/application server, constituted of appropriate hardware executing software applications capable of performing tasks requested by end-user systems 110. A server system receives a user request from an end-user system and performs the tasks requested in the user request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting end-user system (one of 110) as a corresponding response to the user request. The results may be accompanied by specific user interfaces (e.g., web pages) for displaying the results to a requesting user.

In one embodiment, software applications containing one or more components are deployed in nodes 160 of computing infrastructure 130. Examples of such software include, but are not limited to, data processing (e.g., batch processing, stream processing, extract-transform-load (ETL)) applications, Internet of things (IoT) services, mobile applications, and web applications. Computing infrastructure 130 along with the software applications deployed there is viewed as a computing environment (135). It should be noted that in the disclosure herein, computing environment 135 includes computing infrastructure 130 and the software applications deployed thereon.

It may be appreciated that each of nodes 160 has a fixed number of resources such as memory (RAM), CPU (central processing unit) cycles, persistent storage, etc. that can be allocated to (and accordingly used by) software applications (or components thereof) executing in the node. Other resources that may also be provided associated with the computing infrastructure (but not specific to a node) include public IP (Internet Protocol) addresses, etc. In addition to such infrastructure resources, application resources such as database connections, application threads, etc. may also be allocated to (and accordingly used by) the software applications (or components thereof). Accordingly, it may be desirable to monitor and manage the resources consumed by computing environment 135.

Performance manager 170 aids in the management of the performance of computing environment 135, in terms of managing the various resources noted above. Performance managers 170 collects and/or generates performance metrics as a time-based sequence of values and predicts outliers for such performance metrics. The prediction of outliers is typically based on previously collected/generated metric values, and as such requires performance manager 170 to be operative for a reasonable duration (e.g., a week, a month) before being able to predict the outliers with reasonable accuracy.

However, when computing environment 135 is a new computing environment, such a requirement of reasonable duration operation is not feasible. It is generally desirable that performance manager 170 start outlier prediction with desired accuracy as soon as possible after deployment in computing environment 135.

Model selector 150, provided according to several aspects of the present disclosure, facilitates accelerating outlier prediction of performance metrics when deploying a performance manager (170) in a new computing environment (135). Though shown internal to computing infrastructure 130, in alternative embodiments, model selector 150 may be implemented external internal to computing infrastructure 130, for example, as a separate system connected to Internet 120. The manner in which model selector 150 facilitates accelerating outlier prediction of performance metrics is described below with examples.

### 3. Accelerating Outlier Prediction of Performance Metrics

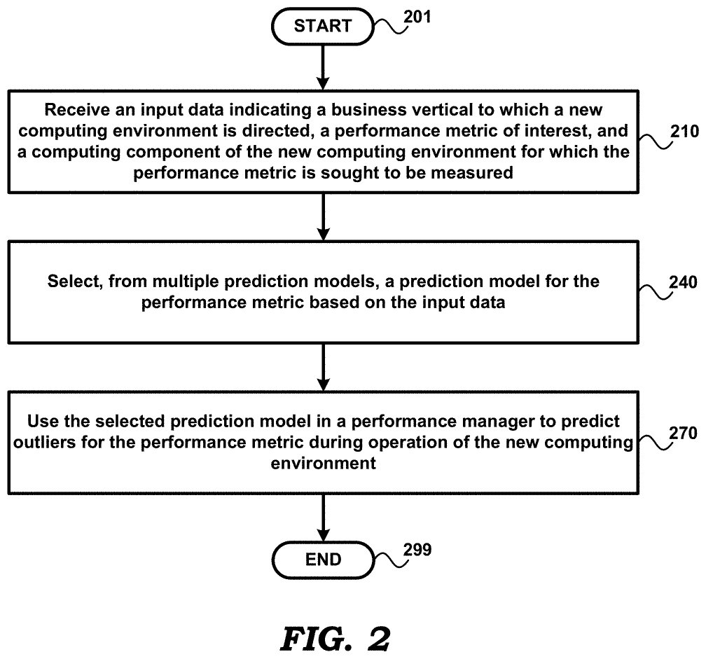

FIG. 2 is a flow chart illustrating the manner in which accelerating outlier prediction of performance metrics in a performance manager (170) deployed in a new computing environment (135) is facilitated according to aspects of the present disclosure. The flowchart is described with respect to the systems of FIG. 1, in particular model selector 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, model selector 150 receives an input data indicating a business vertical to which new computing environment 135 is directed, a performance metric of interest (e.g., CPU, Memory) and a computing component of the new computing environment 135 for which the performance metric is sought to be measured. The input data may be received from one of end-user systems 110.

The computing component may be one of application components (such as web server, database, etc.) of the software applications deployed in computing environment 135 or an infrastructure component (such as server systems 160, database systems, etc.). According to an aspect, the input data also includes a business functionality (e.g., Hotels, Flights, Net Banking) in which the performance metric of interest is sought to be measured.

In step 240, model selector 150 selects, from multiple prediction models, a prediction model for the performance metric of interest, based on the input data. According to an aspect, the selection is performed by comparing the input data to corresponding combinations of business vertical, performance metric, business functionality and computing component associated with the multiple prediction models.

A specific prediction model whose associated specific combination closely matches the input data is identified as the selected prediction model. The term “closely matches” implies that the match may be an exact match (all of the individual values of the specific combination are the same as the corresponding values in the input data) or a partial match (e.g., when only some of the individual values are the same and the other values are comparably similar within a predefined margin), which can be determined any of several known ways.

In step 270, the selected prediction model is used in a performance manager (170) to predict outliers for the performance metric of interest during operation of new computing environment 135. It should be appreciated that the usage of the selected prediction model facilitates outlier prediction to be performed with reasonably accuracy as soon as possible after deployment of performance manager 170 in new computing environment 135. Control passes to step 299, where the flowchart ends.

Accordingly, model selector 150 facilitates accelerating outlier prediction of performance metrics in performance manager 170 deployed in new computing environment 135. The manner in which model selector 150 provides several aspects of the present disclosure according to the steps of FIG. 2 is illustrated below with examples.

### 4. Illustrative Example

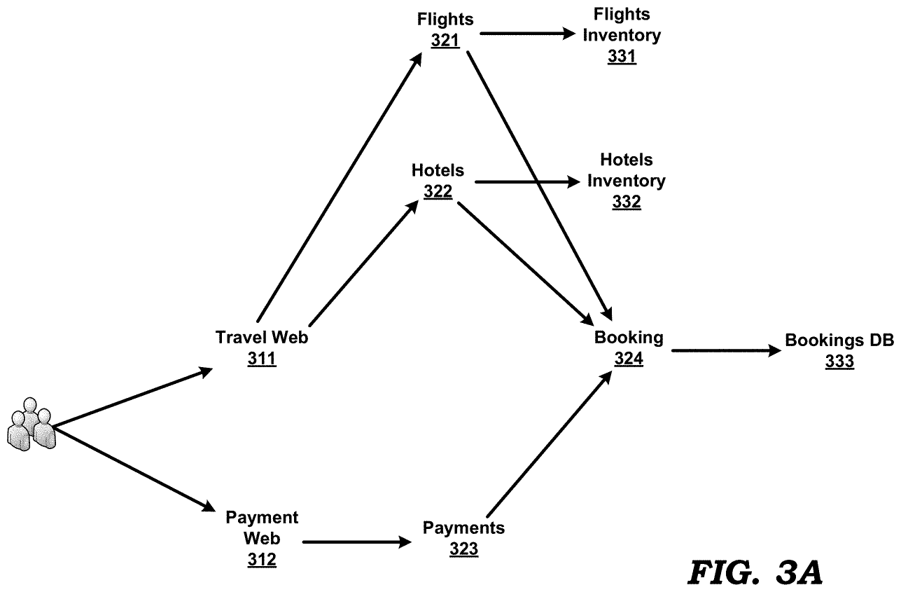

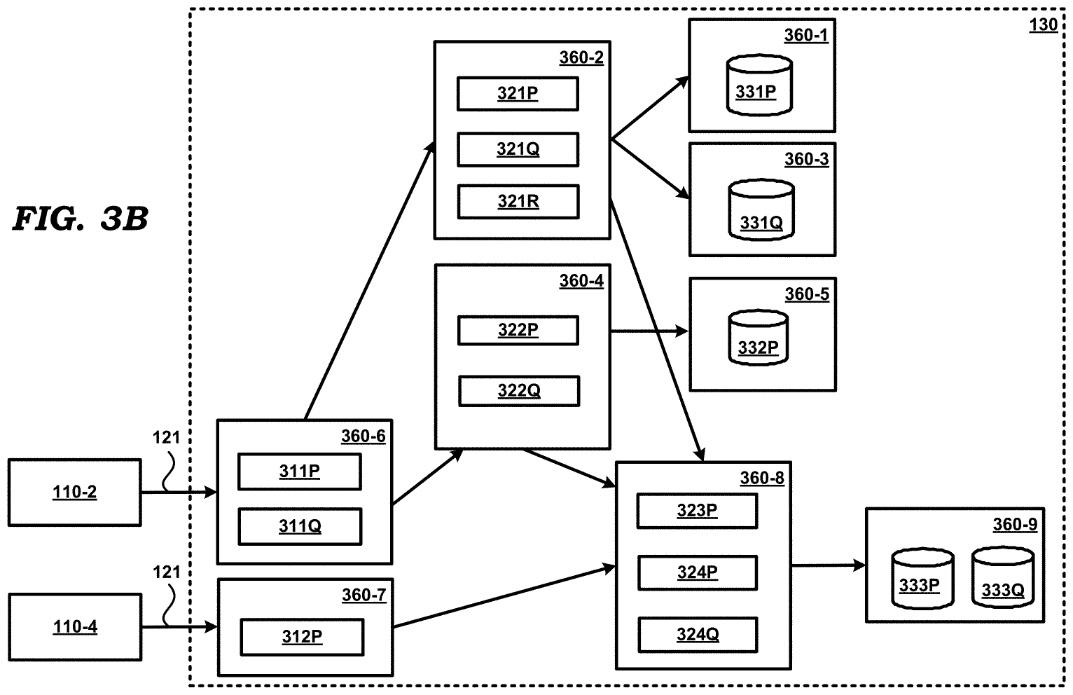

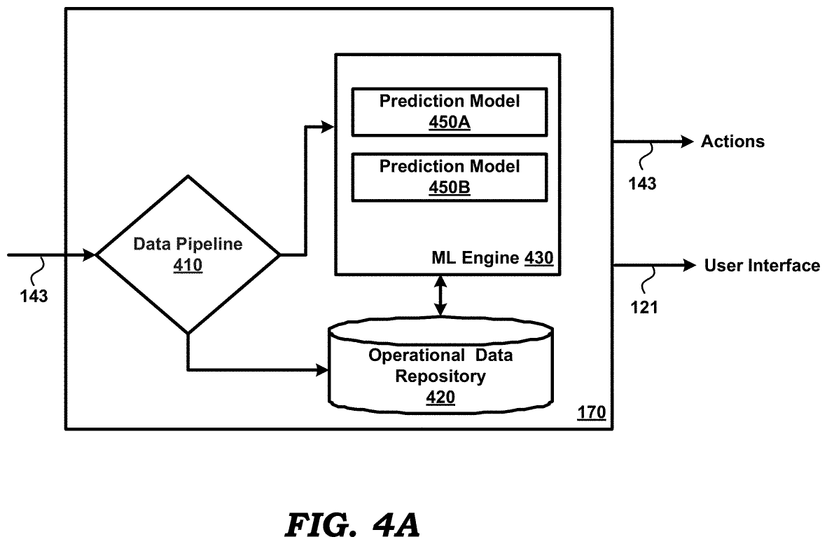

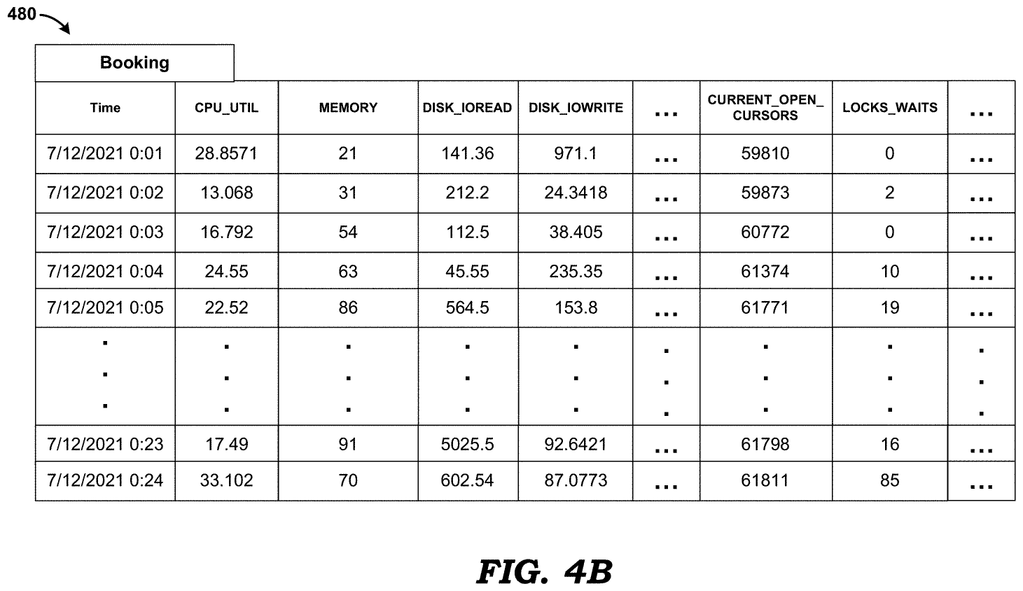

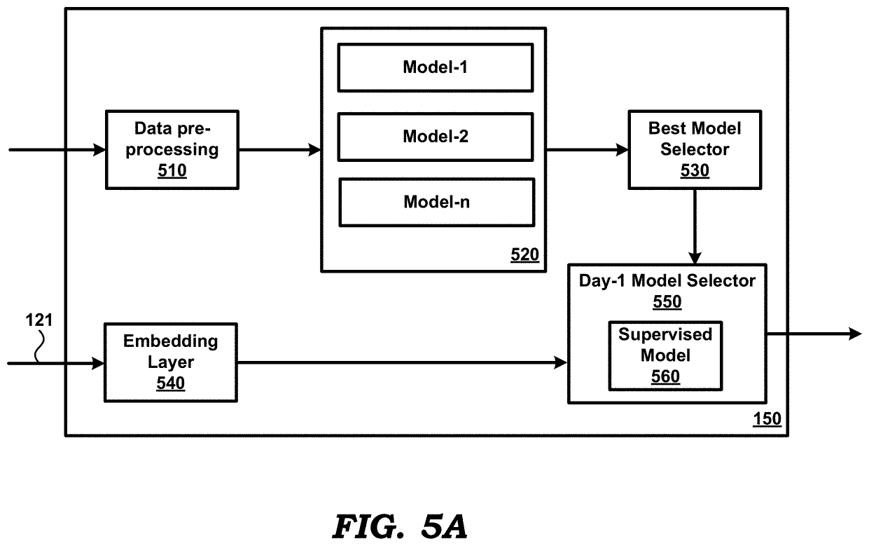

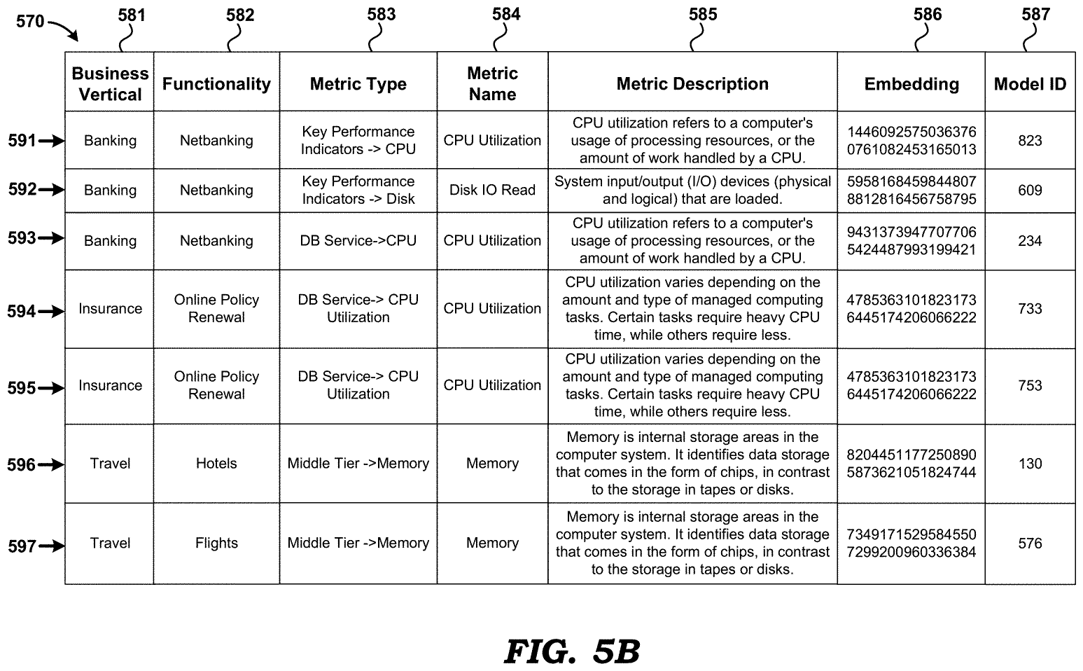

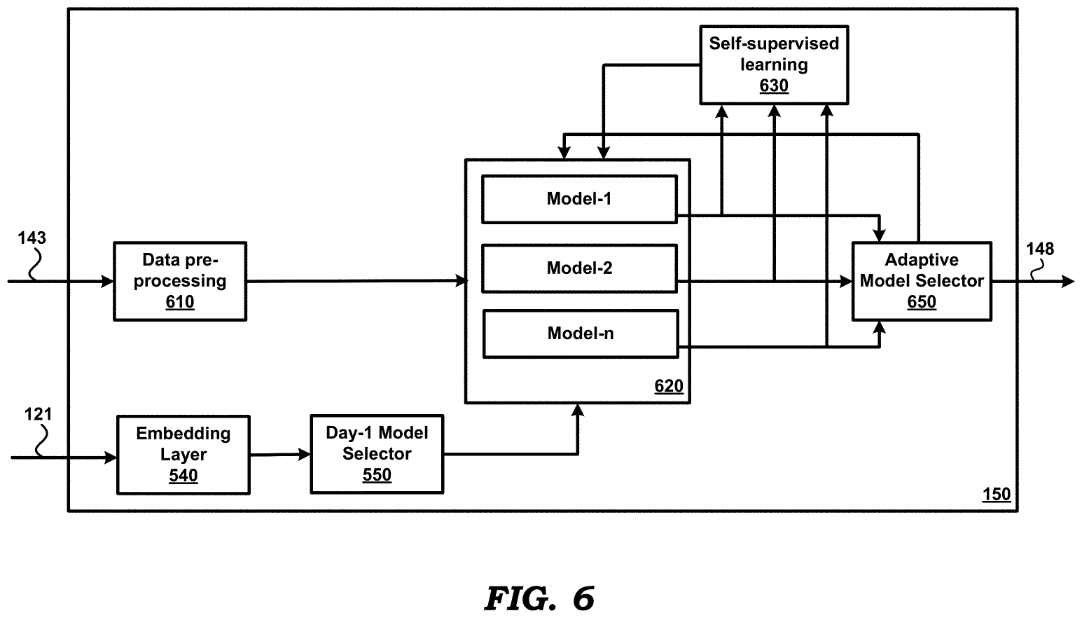

FIGS. 3A, 3B, 4A, 4B, 5A, 5B and 6 illustrate the manner in which accelerating outlier prediction of performance metrics in a performance manager (170) deployed in a new computing environment (135) is facilitated in one embodiment. Broadly, FIGS. 3A and 3B illustrate the manner in which a software application is deployed in nodes 160 of computing infrastructure 130, FIGS. 4A and 4B illustrates the operation of a performance manager (170) and FIGS. 5A, 5B and 6 illustrate the manner in which a prediction model used by performance manager (170) is selected according to several aspects of the present disclosure. Each of the Figures is described in detail below.

FIG. 3A depicts the details of a software application in one embodiment. For illustration, the software application is assumed to be an online travel application that enables users to search and book both flights and hotels. The online travel application is shown containing various components such as front-ends 311-312 (travel web and payment web respectively), backend services 321-324 (flights, hotels, payments and booking respectively) and data stores 331-333 (flights inventory, hotels inventory and bookings DB respectively).

Each of front-ends 311 and 312 is designed to process user requests received from external systems (such as end-user systems 110) connected to Internet 120 and send corresponding responses to the requests. For example, Travel Web 311 may receive (via path 121) user requests from a user using end-user system 110-2, process the received user requests by invoking one or more backend services (such as 321-323), and then send results of processing as corresponding responses to end-user systems 110-2. The responses may include appropriate user interfaces for display in the requesting end-user system (110-2). Payment Web 312 may similarly interact with end-user system 110-2 (or other end-user systems) and facilitate the user to make online payments.

Each of backend services 321-324 implements corresponding functionalities of the software application. Example of backend services are Flights service 331 providing the functionality of search of flights, Hotels service 322 providing the functionality of search of hotels, etc. A backend service (e.g., Flights service 321) may access/invoke other backend services (e.g. Booking service 324) and/or data stores (e.g. Flights Inventory 331) for providing the corresponding functionality.

Each of data stores 331-333 represents a storage component that maintains data used by other components (e.g., services, front-ends) of the software application. As noted above, each of the data stores may be implemented as a database server or file system based on the implementation of the software application.

The manner in which the various components of the software application (online travel application) are deployed in a computing infrastructure (130) is described below with examples.

FIG. 3B depicts the manner in which a software application is deployed in a computing infrastructure in one embodiment. In particular, the Figure depicts the manner in which the online travel application shown in FIG. 3A is deployed in computing infrastructure 130.

In one embodiment, virtual machines (VMs) form the basis for executing various software applications (or components thereof) in processing nodes/server systems of computing infrastructure 130. As is well known, a virtual machine may be viewed as a container in which software applications (or components thereof) are executed. A processing node/server system can host multiple virtual machines, and the virtual machines provide a view of a complete machine (computer system) to the applications/components executing in the virtual machine.

VMs 360-1 to 360-9 represent virtual machines provisioned on nodes 160 of computing infrastructure 130. Each of the VM is shown executing one or more instances (indicated by the suffix P, Q, R, etc.) of web portals 311-312 (implementing front-ends 311-312), application services 321-324 (implementing backend services 321-324) and/or data access interfaces 331-333 (implementing data stores 331-333). Such multiple instances may be necessitated for load balancing, throughput performance, etc. as is well known in the relevant arts. For example, VM 350-6 is shown executing two instances 311P and 311Q of the “Travel Web” web portal.

Thus, a software application (online travel application) containing one or more components is deployed in nodes 160 of computing infrastructure 130. It may be noted that the software application along with computing infrastructure 130 forms new computing environment 135 to which a performance manager (170) is deployed. The manner in which a performance manager (170) normally operates to predict outliers is described below with examples.

### 5. Performance Manager

FIG. 4A is a block diagram depicting an example implementation of a performance manager (170) in one embodiment. The block diagram is shown containing data pipeline 410, operational data repository (ODR) 420 and ML engine 430 (in turn, shown containing prediction models 450A and 450B). Each of the blocks is described in detail below.

Data pipeline 410 receives (via path 143) receives the details of the resources used by the software application (performance metrics) for processing the user requests from nodes 160 of cloud infrastructure 130. The resources may be infrastructure resources such as CPU, memory, disk storage, file system, cache, etc. or application resources such as database connections, database cursors, threads, etc. In one embodiment, the performance metrics are captured for different block durations of 1 minute each. It should be appreciated that the block duration can be of fixed or variable time span, even though the embodiments below are described with respect to a fixed time span (e.g., one minute). Similarly, block durations can be non-overlapping time spans (as in the embodiments described below) or overlapping (e.g., sliding window).

FIG. 4B is a resource table depicting the usage of the resources by a software application (performance metrics) deployed in a computing infrastructure in one embodiment. In particular, resource table 480 depicts the performance metrics for the computing component “Booking” of the online travel application depicted in FIGS. 3A-3B deployed in nodes 160 of computing infrastructure 130.

In resource table 480, the columns indicate the resources such as “CPU_UTIL”, “MEMORY”, etc., while the rows indicate the block durations of one minute each. Each cell (at the intersection of a row and a column) thus indicates the resource consumption metric for the corresponding resource in respective block duration. For example, resource table 480 indicates that the # (number) of DISK IO write operations performed by the computing component “Booking” in the block duration “7/12/2021 0:05” (that is from “0:04” to “0:05”) is 153.8.

Similar tables may be generated/maintained for different components of the software application. In addition, the resource usage for all components may be tallied to generate a resource table for the software application as a whole.

It may be appreciated that for a performance metric (such as CPU_UTIL), the various values in the corresponding column may be viewed as a time series. When any prediction of outliers for the performance metric is based only on the previously observed values (historical data) of the performance metric, such a time series is referred to as a univariate time series. This is in contrast to multivariate time series, where the prediction of outliers is based on multiple time series (e.g., capacity planning, which is dependent on multiple performance metric time series such as CPU_UTIL and MEMORY). Aspects of the present disclosure are directed to univariate time series, that is, for performance metrics whose outlier prediction is based on historical data of the same (or a single) performance metric.

Referring again to FIG. 4A, data pipeline 410 stores the resource table (480) in ODR 420. ODR 420 represents a data store that maintains portions of resource usage data. Though shown internal to performance manager 170, in alternative embodiments, ODR 420 may be implemented external to performance manager 170, for example, in one or more of nodes 160. Data pipeline 410 also forwards the resource usages data to ML engine 430.

ML engine 430 generates and maintains various models that correlate the data received from data pipeline 410. The models may be generated using any machine learning approach such as KNN (K Nearest Neighbor), Decision Tree, etc. Various other machine learning approaches can be employed, as will be apparent to skilled practitioners, by reading the disclosure provided herein. In an embodiment, supervised machine learning approaches are used.

Each of prediction models 450A and 450B correlates resource usage of various components of software application (table 300) to the corresponding time instances. Prediction models 450A/450B may represent different models used to correlate different performance metrics of the same component, or models used to correlate the same performance metric for different components or for the software application as a whole. It may be appreciated that in actual implementations, ML engine 430 may include multiple different models (similar to 450A/450B) corresponding to different requirements.

The models are thereafter used to predict the resource usage of the software application at future time instances. As noted above, when the predicted resource usage for a performance metric in a future time instance is determined to deviate substantially from the normal metric values in the same environment context, an outlier is identified to exist. The term “same environment context” indicates that environment factors such as the date, time of day, number of applications executing, number of requests received, etc. are same/similar when the metric values are measured. For example, when the CPU usage is determined/predicted to be 90% for a time window of 8 am-9 am on a normal Saturday without any special events/promotions and when the normal metric value for CPU for same environment context (8 am-9 am for other Saturdays without any special events/promotions) is 30%, an outlier is deemed to have occurred. It may be appreciated that there may be complex univariate outliers where the time series data (performance metric) has an increasing or decreasing trend (with the outlier not following the trend). Such a trend means that the mean and the variance of the time series shifts over time. In such a scenario, the outlier prediction needs to be implemented to understand such shifts and predict accordingly.

Upon identification of such outliers, performance manager 170 may perform corrective actions by sending appropriate commands to nodes 160 (via path 143) or provide the outlier information to a user using appropriate user interfaces (via path 121).

It may be appreciated that performance manager 170 is able to predict outliers with reasonable accuracy only after processing a large resource usage set (typically one or more weeks of data). It may accordingly be desirable that such outlier prediction of performance metrics be accelerated in performance managers deployed in new computing environments (135).

Aspects of the present disclosure facilitate the selection of prediction models 450A/450B prior to deployment of performance manager 170 in new computing environment 135. The manner in which model selector 150 facilitates the selection of prediction models 450A/450B for outlier prediction of performance metrics is described below with examples.

### 6. Selecting Prediction Model for Outlier Prediction

FIG. 5A is a block diagram depicting the manner in which a prediction model is selected for usage in a performance manager (170) deployed in a new computing environment (135) in one embodiment. The block diagram is shown containing data pre-processing 510, models 520 (in turn shown containing Model-1, Model-2 . . . Model-n), best model selector 430, embedding layer 440 and day-1 model selector 450 (which in turn is shown containing supervised model 560). All the blocks are shown operating in model selector 150. Each of the blocks is described in detail below.

Data pre-processing 510 receives various time series of interest, performs pre-processing on the received data (e.g., cleaning the data, removal of unexpected values, imputing missing values, etc.) identifies features and forwards the processed data and features to models 520. The time series of interest may include data corresponding to different performance metrics. According to an aspect, the received data is historical data sets (series) obtained prior to receiving the input data (by embedding layer 540). The historical data sets are received from different data sources/computing environments similar to new computing environment 135.

Models 520 represents various machine learning (ML) or deep learning (DL) based models (employing some of the ML approaches noted above) that correlates the received time series/identified with the corresponding time instances. The time series data is fed into each of the models (Model-1, Model-2, etc.) individually and the models learn in parallel. It may be appreciated that the weights of models 520 are thus trained using historical data received from different sources. Accordingly, the sources of the data sets are also captured to enable classification of the different models 520.

According to an aspect, each model of models 520 is associated with a corresponding combination of features such as business vertical, business functionality, business vertical, performance metric, business functionality and computing component describing the computing environment/data source originating the data sets based on which the model has been trained. According to another aspect, a description of the performance metric is also used as part of the combination. It may be appreciated that any combination of features (for example, a subset or superset of the above noted features) may be used to capture the details of the computing environment associated with each of models 520.

In one embodiment, the combinations are in the form of corresponding embedded representations generated based on word embedding. As is well known, word embedding as used in natural language processing (NLP) refers to a method of extracting features out of text and representing the features as a numerical representation, thereby enabling machine learning models to work with textual data. The manner in which the combinations and associated models are maintained is described below with examples.

FIG. 5B is an embedding table depicting the word embeddings corresponding to different combinations and the corresponding models in one embodiment. In embedding table 580, columns 581-585 together indicate the combinations of “Business Vertical”, “Functionality” (business functionality), “Metric Type” (computing component), “Metric Name” (performance metric) and “Metric Description”. Column 586 “Embedding” indicates the numerical representation of the corresponding combination specified in columns 581-585. Column 587 “Model ID” indicates a unique identifier of the model associated with the corresponding embedding, and thereby associated with the combination specified in columns 581-585.

Each of rows 591-597 thus specifies a respective combination, the embedding corresponding to the respective combination and a model associated with the respective combination. It may be appreciated that multiple models of models 520 may be associated with the same combination. The multiple models may differ in the manner in which each model correlates the data based on the ML/DL approach implemented by the model. For example, rows 594 and 595 indicate that different models with identifiers of 733 and 753 are associated with the same combination.

Referring again to FIG. 5A, best model selector 530 selects the best model among models 520 for each unique combination of features. In one embodiment, the selection of the best model for each combination is performed based on the accuracy of the models 520 in predicting outliers of the performance metric in the combination. Alternative measures such as speed of prediction, scalability, precision, recall, F1 score or a combination of these measures may be used as the basis of selecting the best/suitable model for each combination. For example, if the accuracy of two models is similar, then scalability of the two models is compared, and the model with higher scalability is chosen as the best/suitable model for the combination.

In general, best model selector 530 determines a set of prediction models corresponding to different unique combinations from models 520 by including a suitable (in the example above, the best) prediction model corresponding to each unique combination. Referring again to table 570 of FIG. 5B, best model selector 530 may determine that model 753 is better suitable than model 733, for example based on the accuracy of outlier prediction for the performance metric “CPU utilization”, and accordingly include only model 753 in the set of prediction models corresponding to the unique combination shown in columns 581-585 of row 594. Best model selector 530 forwards the set of prediction models along with the associated different unique combinations to day-1 model selector 550.

Embedding layer 540 receives the details of the new computing environment in the form of input data from one of end user systems 110 (via path 121). The input data indicates for the new computing environment—a business vertical, performance metric of interest, a computing component, a business functionality and a metric description. For illustration, the aspects of the present disclosure are described below assuming that the input data for the new computing environment is [“Travel”, “Memory”, “Middle Tier->Memory”, “Flights”, “Memory is internal storage areas in the computer system. It identifies data storage that comes in the form of chips, in contrast to the storage in tapes or disks”].

Embedding layer 540 receives the above noted input data, converts the received details into a corresponding embedded representation (hereinafter referred to as “input embedded representation”) using word embeddings. Embedding layer 540 then forwards the input embedded representation to day-1 model selector 550.

Day-1 model selector 550 receives the input embedded representation from embedding layer 540 and compares the input embedded representation with the embedded representation of the unique combinations associated with models 520 received from best model selector 530. Day-1 model selector 550 then identifies a specific prediction model in models 520 whose associated specific combination closely matches the input embedded representation as the day-1 prediction model to be used for the new computing environment. As noted above, the term closely matches may indicate an exact match or a partial match. For the example input data noted above, day-1 model selector 550 may identify model 576 (row 597 of table 670) (assumed to correspond to Model-2 in the Figure) as being the specific prediction model whose values in the associated specific combination exactly match the corresponding values in the input data.

According to an aspect, day-1 model selector 550 trains a new supervised model (560) with the model identifiers of models 520 as corresponding labels and the corresponding embedded representations of the unique combinations. Supervised model 560 is accordingly trained to correlate the embedded representations of the unique combinations with corresponding models. Upon receiving the input embedded representation from embedding layer 540, day-1 model selector 550 provides the input embedded representation as an input to supervised model 560, with supervised model 560 performing the comparing of the input embedded representation with the unique combinations and identifying of the specific prediction model. The specific prediction model (Model-2) is received as output of supervised model 560.

Day-1 model selector 550 then forwards the model information (such as the hyperparameters, weights, algorithm, etc.) corresponding to the identified specific prediction model to performance manager 170 (via path 148). Performance manager 170 may then use the specific prediction model (Model-2) as one of prediction models 450 for predicting outliers of the performance metric “Memory” during the operation of new computing environment 135. It may be appreciated that selection and usage of previously trained models may be termed “zero-knowledge” as it uses pre-trained weights and does not require any data to be ingested for predicting outliers.

It may be further appreciated that the above operation of model selector 150 in the selection of a prediction model for use in a performance manager (170) may predict outliers with reasonable accuracy if the match of the input data with the specific combination is an exact match. However, in many scenarios, it may not be feasible to find an exact match. Accordingly, a prediction model whose combination has the best partial match with the input data may be identified and used in performance manager 170 when deployed in new computing environment 135.

An aspect of the present disclosure facilitates identification of better prediction models during the operation of new computing environment 135 and switching to the better prediction models. The manner in which model selector 150 facilitates such identification and switching is described below with examples.

### 7. Switching Prediction Model for Outlier Prediction

FIG. 6 is a block diagram depicting the manner in which a prediction model is selected for usage in a performance manager (170) during operation of a new computing environment (135) in one embodiment. The block diagram is shown containing data pre-processing 610, models 620 (in turn shown containing Model-1, Model-2 . . . Model-n), self-supervised learning 630 and adaptive model selector 650, in addition to embedding layer 540 and day-1 model selector 550. All the blocks are shown operating in model selector 150. Each of the blocks is described in detail below.

Embedding layer 540 and day-1 model selector 550 operate similar to the corresponding blocks in FIG. 5A, and accordingly their description is not repeated here for conciseness. Embedding layer 540 and day-1 model selector 550 operate together to provide the initially selected/day-1 prediction model (model 576 in row 597 of table 670 corresponding to Model-2 in models 520) as an input to models 620.

Data pre-processing 610 operates similarly to data pre-processing 510 but performs the operations of pre-processing and identification of features based on current data sets received (via path 143) from new computing environment 135. Consequently, models 620 operate similar to models 520 but with training of the models Model-1, Model-2, etc. being based on the current data sets. It may be appreciated that the weights of models 620 are thus trained using historical data received from different sources and also the current data sets received from new computing environment 135. In other words, the training of models 520 is continued with the current data sets to form models 620.

Self-supervised learning 630 automates the task of correlating the outputs of models 620 with the (initially and thereafter) selected prediction models for usage in performance manager 170. As is well known, self-supervised learning 630 provides additional inputs to models 620 that facilitate the individual models to modify their weights, correlation approaches, etc. to achieve higher accuracies of the outputs, here, the accuracies in outlier predictions.

The calibration of the accuracy of models 620 is performed based on the inputs received from self-supervised learning and the feedback received from adaptive model selector 650. As is well known, such calibration typically entails fine tuning the weights of the historical models (520) using data specific to the new computing environment (current datasets). This is typically achieved by freezing the first n-1 layers of the models and adding a dense layer at the end and fine tuning only the final layers. Based on such calibration, the selected model (to be used in performance manager 170) may change over time as more data/knowledge about the time series features is acquired by processing of the current datasets. However, such learning process and the convergence to a stable model and outlier prediction can happen much more quickly as the models are already fine-tuned based on historical data. Such a system is flexible enough to handle concept drift in time series as well as new types of metrics which have not been processed before.

Adaptive model selector 650 (also referred to as day-n model selector) receives the details of the various models 620 such as their accuracies of outlier prediction and the associated combinations, and determines whether there is another prediction model of models 620 is better than the initially selected/day-1 prediction model (Model-2 in models 520), with another prediction model having an associated combination same/similar to the input data. Such another prediction model may typically exist if the initial match for identifying day-1 prediction model was based on a partial match. However, another prediction model may exist even when the initial match was an exact match.

It may be appreciated that different parameters may be used as the basis of determining whether another prediction model is better than day-1 prediction model. For example, if another prediction model has higher accuracy (and/or speed) for outlier prediction as compared to day-1 prediction model, though another prediction model is directed to a different (but similar) business vertical or business functionality. For the example input data noted above, adaptive model selector 650 may identify model 130 (row 596 of table 670) (assumed to correspond to Model-10 in models 620) as being better than day-1 selected model Model-2.

In the event that such a new prediction model better than day-1 prediction model is determined, adaptive model selector 650 sends the model information related to the new prediction model to performance manager 170. Performance manager 170, in turn, starts using the new prediction model (Model-10) as one of prediction models 450 for predicting outliers of the performance metric “Memory” during the operation of new computing environment 135. In other words, the prediction model used for predicting outliers is switched to the new prediction model Model-10 from the day-1/previous prediction model Model-2, thereby improving the prediction of outliers for the performance metric of interest (“Memory”).

It may be appreciated that current state-of-the-art systems for univariate time series modeling requires weeks of data of the new computing environment to start stable outlier predictions. Aspects of the present disclosure cut the wait time to a few minutes or 1 hour at the most, thereby enabling customers (of the new computing environment) to get ML based insights from day 1 and reduce bootstrapping time (as according to an aspect, bootstrapped data from historical datasets is already available.

It should be further appreciated that the features described above can be implemented in various embodiments as a desired combination of one or more of hardware, software, and firmware. The description is continued with respect to an embodiment in which various features are operative when the software instructions described above are executed.

### 8. Digital Processing System

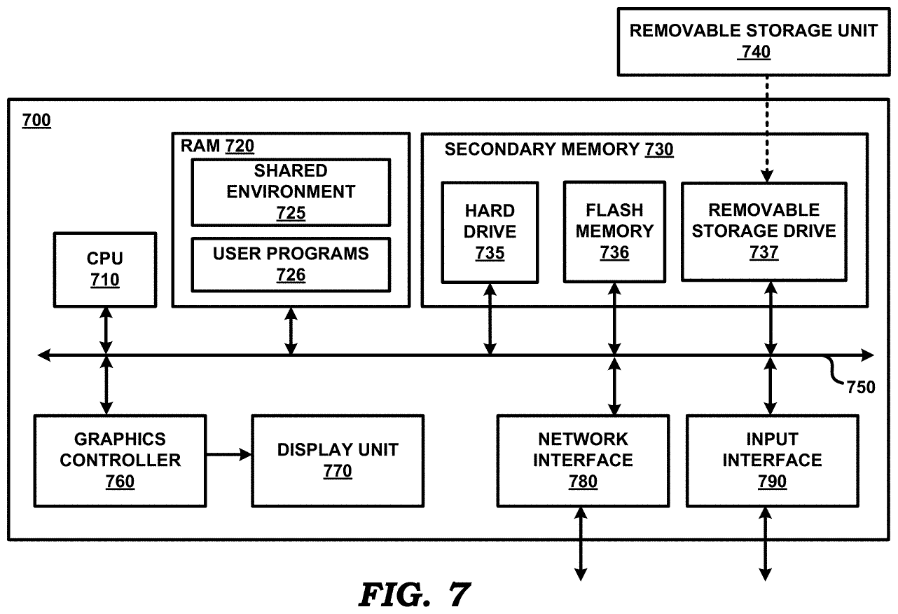

FIG. 7 is a block diagram illustrating the details of digital processing system 700 in which various aspects of the present disclosure are operative by execution of appropriate executable modules. Digital processing system 700 may correspond to model selector 150 (or any system implementing model selector 150).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or other user programs 726 (such as other applications, DBMS, etc.). In addition to shared environment 725, RAM 720 may contain other software programs such as device drivers, virtual machines, etc., which provide a (common) run time environment for execution of other/user programs.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems connected to the networks.

Secondary memory 730 may contain hard drive 735, flash memory 736, and removable storage drive 737. Secondary memory 730 may store the data (e.g., data portions of FIGS. 4B and 5B) and software instructions (e.g., for implementing the steps of FIG. 2, for implementing the blocks of FIGS. 4A, 5A and 6), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A non-transitory machine-readable medium storing one or more sequences of instructions for outlier prediction of performance metrics in a performance manager deployed in a new computing environment, wherein execution of said one or more instructions by one or more processors contained in a digital processing system causes said digital processing system to perform the actions of:
receiving an input data specifying a business vertical to which said new computing environment is directed, a first performance metric of interest, and a computing component of said new computing environment for which said first performance metric is sought to be measured;
selecting, from a first plurality of prediction models, a first prediction model for said first performance metric, based on said input data; and
using said first prediction model in said performance manager to predict outliers for said first performance metric during operation of said new computing environment.

2. The non-transitory machine-readable medium of claim 1, wherein said input data further comprises a business functionality in which said first performance metric is sought to be measured.

3. The non-transitory machine-readable medium of claim 2, further comprising one or more instructions for:
training a second plurality of prediction models based on a plurality of historical data sets, wherein each of said second plurality of prediction models is associated with a respective one of a plurality of combinations of business vertical, performance metric, business functionality and computing component; and
determining said first plurality of prediction models from said plurality of prediction models by including a respective suitable prediction model corresponding to each combination in said plurality of combinations.

4. The non-transitory machine-readable medium of claim 3, wherein said selecting comprises one or more instructions for:
comparing said input data with said plurality of combinations associated with said first plurality of prediction models; and
identifying a specific prediction model in said first plurality of prediction models whose associated specific combination closely matches said input data as said first prediction model.

5. The non-transitory machine-readable medium of claim 4, further comprising one or more instructions for:
continuing training of said second plurality of prediction models based on a plurality of current data sets;
determining, at a first time instance, whether a second prediction model of said second plurality of prediction models is better than said first prediction model, said second prediction model being associated with said specific combination; and
switching to said second prediction model from said first prediction model if said second prediction model is determined to be better than said first prediction model,
wherein said using, after said switching, uses said second prediction model in said performance manager to predict outliers for said first performance metric during operation of said new computing environment.

6. The non-transitory machine-readable medium of claim 5, wherein said plurality of combinations is in the form of corresponding embedded representations, further comprising one or more instructions for:
training a new supervised model with the model identifiers of said first plurality of prediction models as corresponding labels and said corresponding embedded representations;
converting said input data to an input embedded representation capturing said business vertical, said first performance metric of interest, said computing component and said business functionality;
providing said input embedded representation as an input to said new supervised model, wherein said comparing and said identifying is performed by said new supervised model, wherein said first prediction model is received as output of said new supervised model.

7. The non-transitory machine-readable medium of claim 6, wherein said input data further comprises a metric description describing said first performance metric of interest, wherein each of said plurality of combinations includes a description of the corresponding performance metric.

8. A computer implemented method for outlier prediction of performance metrics in a performance manager deployed in a new computing environment, said method comprising:
receiving an input data specifying a business vertical to which said new computing environment is directed, a first performance metric of interest, and a computing component of said new computing environment for which said first performance metric is sought to be measured;
selecting, from a first plurality of prediction models, a first prediction model for said first performance metric, based on said input data; and
using said first prediction model in said performance manager to predict outliers for said first performance metric during operation of said new computing environment.

9. The method of claim 8, wherein said input data further comprises a business functionality in which said first performance metric is sought to be measured.

10. The method of claim 9, further comprising:
training a second plurality of prediction models based on a plurality of historical data sets, wherein each of said second plurality of prediction models is associated with a respective one of a plurality of combinations of business vertical, performance metric, business functionality and computing component; and
determining said first plurality of prediction models from said plurality of prediction models by including a suitable prediction model corresponding to each combination in said plurality of combinations.

11. The method of claim 10, wherein said selecting comprises:
comparing said input data with said plurality of combinations associated with said first plurality of prediction models; and
identifying a specific prediction model in said first plurality of prediction models whose associated specific combination closely matches said input data as said first prediction model.

12. The method of claim 11, further comprising:
continuing training of said second plurality of prediction models based on a plurality of current data sets;
determining, at a first time instance, whether a second prediction model of said second plurality of prediction models is better than said first prediction model, said second prediction model being associated with said specific combination; and
switching to said second prediction model from said first prediction model if said second prediction model is determined to be better than said first prediction model,
wherein said using, after said switching, uses said second prediction model in said performance manager to predict outliers for said first performance metric during operation of said new computing environment.

13. The method of claim 12, wherein said plurality of combinations is in the form of corresponding embedded representations, further comprising:
training a new supervised model with the model identifiers of said first plurality of prediction models as corresponding labels and said corresponding embedded representations;
converting said input data to an input embedded representation capturing said business vertical, said first performance metric of interest, said computing component and said business functionality;
providing said input embedded representation as an input to said new supervised model, wherein said comparing and said identifying is performed by said new supervised model, wherein said first prediction model is received as output of said new supervised model.

14. The method of claim 13, wherein said input data further comprises a metric description describing said first performance metric of interest, wherein each of said plurality of combinations includes a description of the corresponding performance metric.

15. A digital processing system comprising:
a random access memory (RAM) to store instructions for outlier prediction of performance metrics in a performance manager deployed in a new computing environment; and
one or more processors to retrieve and execute the instructions, wherein execution of the instructions causes the digital processing system to perform the actions of:
receiving an input data specifying a business vertical to which said new computing environment is directed, a first performance metric of interest, and a computing component of said new computing environment for which said first performance metric is sought to be measured;
selecting, from a first plurality of prediction models, a first prediction model for said first performance metric, based on said input data; and
using said first prediction model in said performance manager to predict outliers for said first performance metric during operation of said new computing environment.

16. The digital processing system of claim 15, wherein said input data further comprises a business functionality in which said first performance metric is sought to be measured, further performing the actions of:
training a second plurality of prediction models based on a plurality of historical data sets, wherein each of said second plurality of prediction models is associated with a respective one of a plurality of combinations of business vertical, performance metric, business functionality and computing component; and
determining said first plurality of prediction models from said plurality of prediction models by including a suitable prediction model corresponding to each combination in said plurality of combinations.

17. The digital processing system of claim 16, wherein for said selecting, said digital processing system performs the actions of:
comparing said input data with said plurality of combinations associated with said first plurality of prediction models; and
identifying a specific prediction model in said first plurality of prediction models whose associated specific combination closely matches said input data as said first prediction model.

18. The digital processing system of claim 17, further performing the actions of:
continuing training of said second plurality of prediction models based on a plurality of current data sets;
determining, at a first time instance, whether a second prediction model of said second plurality of prediction models is better than said first prediction model, said second prediction model being associated with said specific combination; and
switching to said second prediction model from said first prediction model if said second prediction model is determined to be better than said first prediction model,
wherein said using, after said switching, uses said second prediction model in said performance manager to predict outliers for said first performance metric during operation of said new computing environment.

19. The digital processing system of claim 18, wherein said plurality of combinations is in the form of corresponding embedded representations, further performing the actions of:
training a new supervised model with the model identifiers of said first plurality of prediction models as corresponding labels and said corresponding embedded representations;
converting said input data to an input embedded representation capturing said business vertical, said first performance metric of interest, said computing component and said business functionality;
providing said input embedded representation as an input to said new supervised model, wherein said comparing and said identifying is performed by said new supervised model, wherein said first prediction model is received as output of said new supervised model.

20. The digital processing system of claim 19, wherein said input data further comprises a metric description describing said first performance metric of interest, wherein each of said plurality of combinations includes a description of the corresponding performance metric.
